(19) United States
(12) Patent Application Publication
(10) Pub. No.: US 2016/0150469 A1
(43) Pub. Date: May 26, 2016

(54) METHOD FOR PERFORMING OPPORTUNISTIC POWER SAVING IN AN ELECTRONIC DEVICE, AND ASSOCIATED APPARATUS

(71) Applicant: MEDIATEK INC., Hsin-Chu (TW)

(72) Inventors: Tsai-Yuan Hsu, Hsinchu County (TW); Ching-Hwa Yu, Tainan City (TW)

(21) Appl. No.: 14/683,141

(22) Filed: Apr. 9, 2015

Related U.S. Application Data
(60) Provisional application No. 62/082,623, filed on Nov. 21, 2014.

(51) Int. Cl. H04W 52/02; H04L 29/06; H04W 72/04

(52) U.S. Cl. CPC H04W 52/0206; H04W 72/0446; H04W 52/0216; H04L 69/22

(57) ABSTRACT

A method for performing opportunistic power saving in an electronic device and an associated apparatus are provided, where the method includes the steps of: wirelessly receiving at least one portion of a header of a packet, wherein the packet is wirelessly sent from outside the electronic device; determining a transmission time parameter of the packet according to the at least one portion of the header, for timing control of packet-based dozing; and according to header information within the packet, selectively controlling a transceiver of the electronic device to enter a doze state during a remaining transmission time of the packet, to reduce power consumption of the electronic device.

### CROSS REFERENCE TO RELATED APPLICATIONS

This application claims the benefit of U.S. Provisional Application No. 62/082,623, which was filed on Nov. 21, 2014, and is included herein by reference.

### BACKGROUND

The present invention relates to Wireless-Fidelity (Wi-Fi) communications control, and more particularly, to a method for performing opportunistic power saving in an electronic device, and an associated apparatus.

According to the related art, some conventional power saving schemes, such as Legacy Power Saving (Legacy PS), Wi-Fi Multimedia Power Saving (WMM PS), Transmission Opportunity Power Saving (TXOP PS) and Peer-to-Peer Power Saving (P2P PS), are introduced. As a result, it may be achieved to save current consumption in a specified period for non-access point (non-AP) stations (STAs) and P2P devices according to Institute of Electrical and Electronics Engineers (IEEE) 802.11 standards. However, some problems may still exist. For example, there are only service-based power saving schemes, which are typically activated by protocol handshaking, based on IEEE 802.11 standards, where frame exchanges are typically needed to allow a conventional STA device enter a doze state. In another example, there is no power saving scheme in the related art to allow a conventional infrastructure AP device to enter a doze state. As a result, the conventional infrastructure AP device may suffer from high power consumption. In another example, the end user of a conventional electronic device may need to frequently switch off or on the Wi-Fi communications module of the conventional electronic device manually, which brings unpleasant user experience. Thus, a novel method and a corresponding architecture are required to improve the power saving control for an AP.

### SUMMARY

It is an objective of the claimed invention to provide a method for performing opportunistic power saving in an electronic device, and an associated apparatus, in order to solve the above-mentioned problems.

It is another objective of the claimed invention to provide a method for performing opportunistic power saving in an electronic device, and an associated apparatus, in order to allow an infrastructure access point (AP) to enter a doze state.

According to at least one preferred embodiment, a method for performing opportunistic power saving in an electronic device is provided, where the method comprises the steps of: wirelessly receiving at least one portion of a header of a packet, wherein the packet is wirelessly sent from outside the electronic device; determining a transmission time parameter of the packet according to the at least one portion of the header, for timing control of packet-based dozing; and according to header information within the packet, selectively controlling a transceiver of the electronic device to enter a doze state during a remaining transmission time of the packet, to reduce power consumption of the electronic device.

According to at least one preferred embodiment, an apparatus for performing opportunistic power saving in an electronic device is provided, where the apparatus comprises at least one portion of the electronic device. The apparatus may comprise a transceiver and a control module that is coupled to the transceiver. The transceiver is arranged for wirelessly receiving at least one portion of a header of a packet, wherein the packet is wirelessly sent from outside the electronic device. In addition, the control module is arranged for determining a transmission time parameter of the packet according to the at least one portion of the header, for timing control of packet-based dozing. Additionally, according to header information within the packet, the control module selectively controls the transceiver of the electronic device to enter a doze state during a remaining transmission time of the packet, to reduce power consumption of the electronic device.

It is an advantage of the present invention that the present invention method and the associated apparatus can reduce power consumption in an electronic device with fewer side effects. In addition, the present invention method and the associated apparatus can improve the power saving control for an electronic device. As a result, the related art problems (e.g. the problem of high power consumption, and the problem that the end user may need to frequently switch off or on the Wi-Fi communications module manually) can be resolved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for performing opportunistic power saving in an electronic device according to a first embodiment of the present invention.

FIG. 2 illustrates a flowchart of a method for performing opportunistic power saving in an electronic device according to an embodiment of the present invention.

FIG. 3 illustrates an opportunistic packet-based power saving control scheme involved with the method shown in FIG. 2 according to an embodiment of the present invention.

FIG. 4 illustrates some fields of a SIG structure used for determining Wireless-Fidelity (Wi-Fi) physical layer (PHY) capabilities in the method shown in FIG. 2 according to an embodiment of the present invention.

FIG. 5 illustrates some fields of a SIG structure used for determining Wi-Fi PHY capabilities in the method shown in FIG. 2 according to another embodiment of the present invention.

FIG. 6 illustrates some fields of a SIG structure used for determining Wi-Fi PHY capabilities in the method shown in FIG. 2 according to another embodiment of the present invention.

FIG. 7 illustrates some fields of a SIG structure used for determining Wi-Fi PHY capabilities in the method shown in FIG. 2 according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

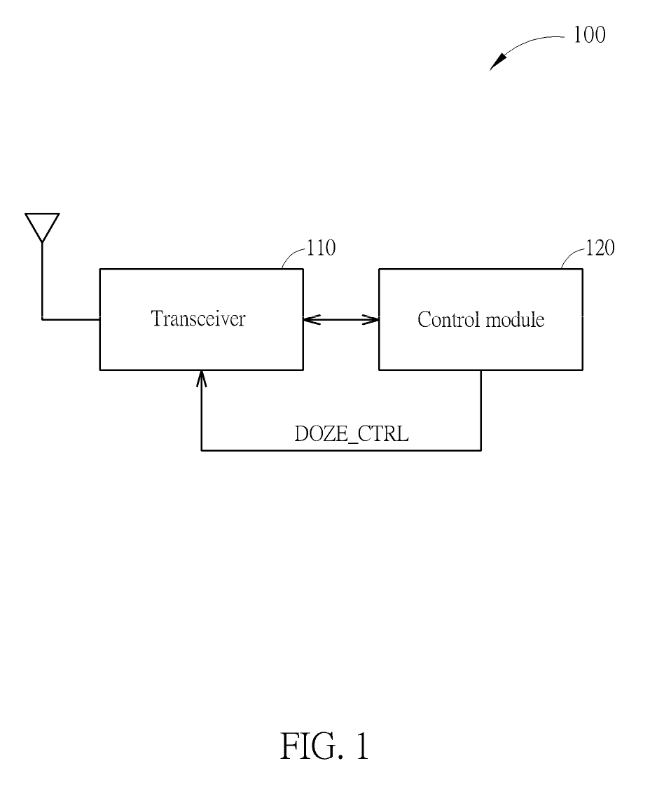

FIG. 1 illustrates a diagram of an apparatus 100 for performing opportunistic power saving in an electronic device according to a first embodiment of the present invention, where the apparatus 100 may comprise at least one portion (e.g. a portion or all) of the electronic device. For example, the apparatus 100 may comprise a portion of the electronic device mentioned above, and more particularly, can be at least one hardware circuit such as at least one integrated circuit (IC) within the electronic device and associated circuits thereof. In another example, the apparatus 100 can be the whole of the electronic device mentioned above. In another example, the apparatus 100 may comprise a system comprising the electronic device mentioned above (e.g. a wireless communications system comprising the electronic device). Examples of the electronic device may include, but not limited to, a mobile phone (e.g. a multifunctional mobile phone), a tablet, and a personal computer such as a laptop computer or a desktop computer.

As shown in FIG. 1, the apparatus 100 may comprise a transceiver 110 and a control module 120 that is coupled to the transceiver 110. For example, the transceiver 110 may be a Wireless-Fidelity (Wi-Fi) transceiver, and the control module 120 may be implemented with at least one processor (e.g. one or more processors) running program instructions. This is for illustrative purposes only, and is not meant to be a limitation of the present invention. In some examples, the control module 120 may be implemented with hardware circuits. According to this embodiment, the transceiver 110 is arranged for wirelessly receiving or transmitting packets for the electronic device. In addition, the control module 120 is arranged for controlling operations of the electronic device, and more particularly, performing packet-based dozing control of the transceiver 110. For example, the control module 120 may utilize a doze control signal DOZE CTRL to switch off the power of the transceiver 110 during a time interval in which a specific packet that is not related to the electronic device is wirelessly transmitted from another electronic device. In another example, the control module 120 may utilize the doze control signal DOZE CTRL to switch on the power of the transceiver 110 during a time interval in which another packet that is related to the electronic device is wirelessly transmitted from the other electronic device. In another example, the control module 120 may utilize the doze control signal DOZE CTRL to switch off the power of the transceiver 110 during a time interval in which another packet that the electronic device cannot decode is wirelessly transmitted from another electronic device. As the transceiver 110 may selectively doze packet by packet under control of the control module 120, the apparatus 100 may reduce power consumption of the electronic device.

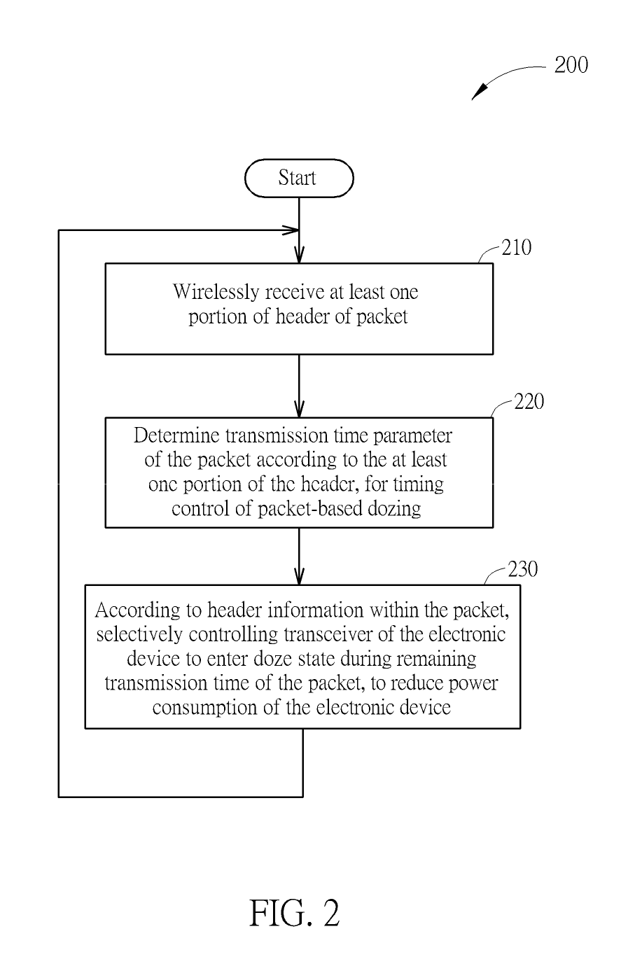

FIG. 2 illustrates a flowchart of a method for performing opportunistic power saving in an electronic device according to an embodiment of the present invention. The method 200 shown in FIG. 2 can be applied to the apparatus 100 shown in FIG. 1, and can be applied to the transceiver 110 and the control module 120 thereof. The method can be described as follows.

In Step 210, the transceiver 110 wirelessly receives at least one portion (e.g. a portion or all) of a header of a packet, where the packet is wirelessly sent from outside the electronic device. For example, the packet may be wirelessly sent from any other electronic device, which is positioned outside the electronic device, and the aforementioned at least one portion of the header may be wirelessly received by the electronic device through the transceiver 110 before a connection between the electronic device and the source of the packet is established.

In Step 220, the control module 120 determines a transmission time parameter of the packet according to the aforementioned at least one portion of the header, for timing control of packet-based dozing. For example, the control module 120 may obtain at least one other parameter (e.g. one or more other parameters) from at least one field (e.g. one or more fields) in the aforementioned at least one portion of the header, and may determine (or calculate) the transmission time parameter according to the aforementioned at least one other parameter. In another example, the control module 120 may directly obtain the transmission time parameter from the aforementioned at least one portion of the header.

In Step 230, according to header information within the packet, the control module 120 selectively controls the transceiver 110 of the electronic device to enter a doze state during a remaining transmission time of the packet, to reduce the power consumption of the electronic device. For example, when the header information within the packet matches a specific predetermined condition, the control module 120 may control the transceiver 110 to enter the doze state during the remaining transmission time of the packet; otherwise, the control module 120 may prevent the transceiver 110 from entering the doze state during the remaining transmission time of the packet. In another example, when the header information within the packet matches one of a plurality of predetermined conditions, the control module 120 may control the transceiver 110 to enter the doze state during the remaining transmission time of the packet; otherwise, the control module 120 may prevent the transceiver 110 from entering the doze state during the remaining transmission time of the packet.

According to this embodiment, the apparatus 100 may further comprise a timer module within the electronic device (e.g. a program module running on the processor), and the apparatus 100 may utilize the timer module to perform at least one timing operation (e.g. one or more timing operations) according to the transmission time parameter. In addition, according to the header information within the packet, the control module 120 may control the transceiver 110 to stay in the doze state during the remaining transmission time of the packet. Based upon the aforementioned at least one timing operation, the control module 120 may control the transceiver 110 to exit the doze state when the remaining transmission time expires, for example, to wirelessly receive at least one portion of the next packet (e.g. a packet wirelessly sent from the same source of the packet mentioned in Step 210, or a packet wirelessly sent from another source). Please note that, although the control module 120 may rapidly determine whether to control the transceiver 110 to enter the doze state, the time that the control module 120 spends on determining whether to control the transceiver 110 to enter the doze state is typically greater than zero. As a result, the remaining transmission time mentioned in Step 230 is typically not equivalent to the time interval represented by the transmission time parameter. For example, the remaining transmission time mentioned in Step 230 may be shorter than the length of the time interval represented by the transmission time parameter. By utilizing the timer module to perform the aforementioned at least one timing operation, the control module 120 may accurately control the time that the transceiver 110 exits the doze state and may start monitoring characteristics of other packets in time.

According to some embodiments, according to the header information within the packet, the control module 120 may determine whether the packet is non-related to the electronic device, to selectively control the transceiver 110 to enter the doze state during the remaining transmission time of the packet. For example, the header information may comprise an Association Identifier (AID). In addition, when the AID in the packet does not match that of the electronic device, the control module 120 may control the transceiver 110 to enter the doze state during the remaining transmission time of the packet. In another example, the header information may comprise a Basic Service Set Identification (BSSID). In addition, when the BSSID in the packet does not match that of the electronic device, the control module 120 may control the transceiver 110 to enter the doze state during the remaining transmission time of the packet.

According to some embodiments, according to the header information within the packet, the control module 120 may determine whether the packet is non-decodable based on predetermined capabilities by the electronic device, to selectively control the transceiver to enter the doze state during the remaining transmission time of the packet. For example, the header information may comprise a data rate (e.g. the data rate for transmitting the data in the associated payload). In addition, when the data rate is an unsupported data rate of the electronic device, the control module 120 may control the transceiver 110 to enter the doze state during the remaining transmission time of the packet. This is for illustrative purposes only, and is not meant to be a limitation of the present invention. According to some embodiments of the present invention, when the data rate of the packet does not match a predetermined data rate of the electronic device, the control module 120 may control the transceiver 110 to enter the doze state during the remaining transmission time of the packet.

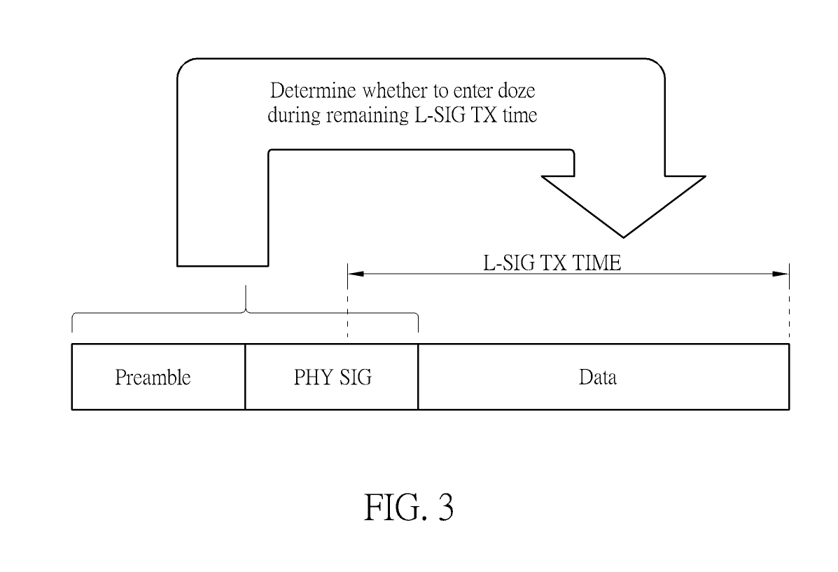

FIG. 3 illustrates an opportunistic packet-based power saving control scheme involved with the method shown in FIG. 2 according to an embodiment of the present invention. For example, the packet mentioned in Step 210 may correspond to the packet format of {Preamble, PHY SIG, Data}, i.e. the preamble of the packet, physical layer signal (PHY SIG)-related fields, and the data carried by the packet. In addition, a legacy signal (L-SIG) transmission (TX) time can be taken as an example of the transmission time parameter mentioned in Step 220, and the time interval represented by the L-SIG TX time may start from a specific field within the PHY SIG of this packet and end at the last bit of this packet. As shown in FIG. 3, according to the header information within the packet (e.g. information within the preamble, and/or information within the PHY SIG), the control module 120 may determine whether the transceiver 110 should enter the doze state during the remaining transmission time mentioned in Step 230, such as the remaining L-SIG TX time (i.e. the remaining time within the L-SIG TX time).

According to this embodiment, after receipt of the PHY SIG, the control module 120 may determine that, for example, the following payload (which may comprise the MAC header) cannot be decoded due to insufficient capabilities of the electronic device (e.g. un-supported rates), or is not necessary to be decoded by scenario (e.g. only mandatory PHY rates of interest as SCAN mode) according to the received PHY characteristics. As a result, the station (STA) role played by the electronic device may enter the doze state during the remaining L-SIG TX time, and therefore, the control module 120 may control the transceiver 110 to enter the doze state during the remaining transmission time mentioned in Step 230, such as the remaining L-SIG TX time. This is for illustrative purposes only, and is not meant to be a limitation of the present invention. After receipt of the PHY SIG, the control module 120 may determine that, for example, the following payload may be dropped due to AID mismatch (e.g. the AID of the packet mentioned in Step 210 does not match that of the electronic device) or BSSID mismatch (e.g. the BSSID of the packet mentioned in Step 210 does not match that of the electronic device). As a result, the STA role played by the electronic device may enter the doze state during the remaining L-SIG TX time, and therefore, the control module 120 may control the transceiver 110 to enter the doze state during the remaining transmission time mentioned in Step 230, such as the remaining L-SIG TX time.

According to some embodiments, after receipt of the PHY SIG, the control module 120 may determine whether the following payload cannot be decoded due to insufficient capabilities of the electronic device, based on some fields of a SIG structure such as that of the PHY SIG. Examples of these fields may include, but not limited to, CCK (for IEEE 802.11b), and those of Legacy SIG (for IEEE 802.11g) such as Rate. For example, the control module 120 may configure Wi-Fi PHY characteristics of interest into the electronic device.

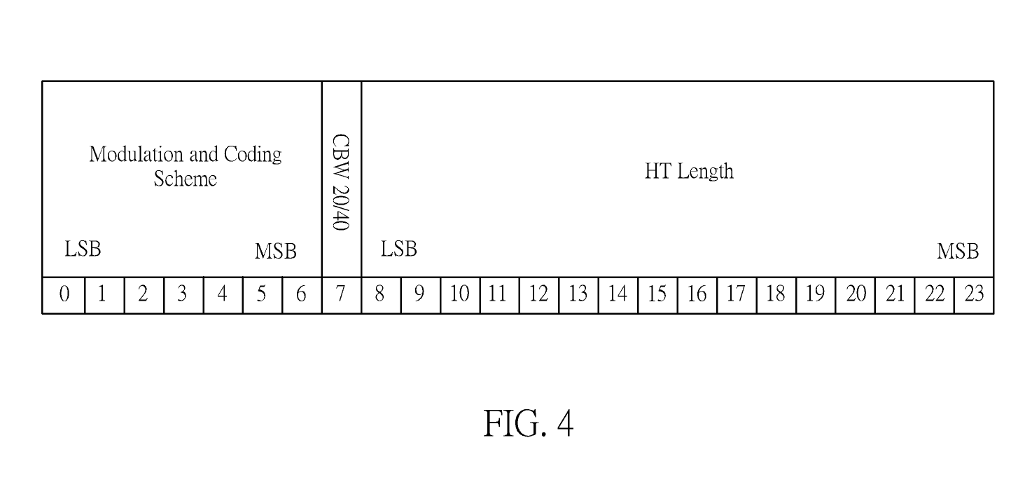

FIG. 4 illustrates some fields of a SIG structure used for determining Wi-Fi physical layer (PHY) capabilities in the method shown in FIG. 2 according to an embodiment of the present invention. For example, this SIG structure can be a HT-SIG₁ structure. For implementation details of the HT-SIG₁ structure, please refer to the associated standards.

According to this embodiment, after receipt of the PHY SIG, the control module 120 may determine whether the following payload cannot be decoded due to insufficient capabilities of the electronic device, based on some fields of this SIG structure. Examples of these fields may include, but not limited to, those of HT SIG (for IEEE 802.11n) such as MCS Set, Maximum MPDU Length, Sounding, Aggregation, Space Time Block Code (STBC), Low Density Parity Check Code (LDPC), and Short GI.

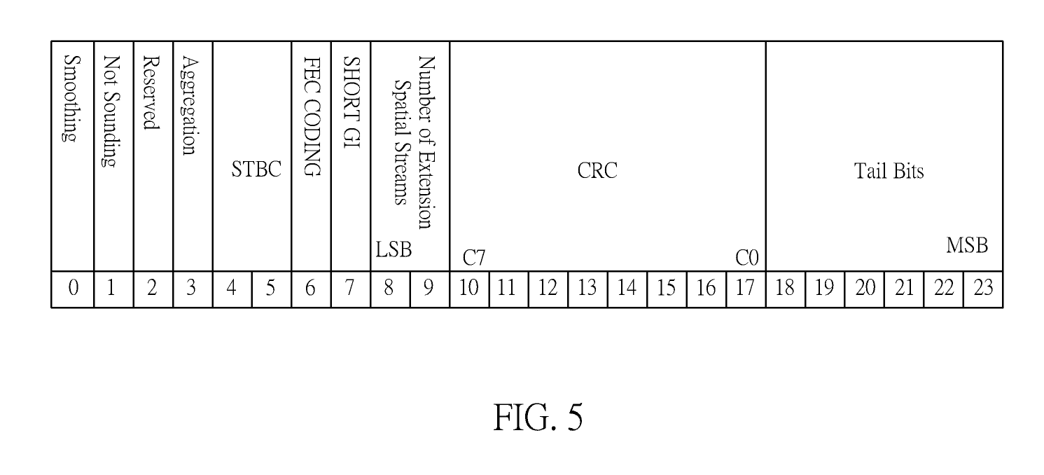

FIG. 5 illustrates some fields of a SIG structure used for determining Wi-Fi PHY capabilities in the method shown in FIG. 2 according to another embodiment of the present invention. For example, this SIG structure can be a HT-SIG₂ structure. For implementation details of the HT-SIG₂ structure, please refer to the associated standards.

According to this embodiment, after receipt of the PHY SIG, the control module 120 may determine whether the following payload cannot be decoded due to insufficient capabilities of the electronic device, based on some fields of this SIG structure. Examples of these fields may include, but not limited to, those of HT SIG (for IEEE 802.11n) such as MCS Set, Maximum MPDU Length, Sounding, Aggregation, STBC, LDPC, and Short GI.

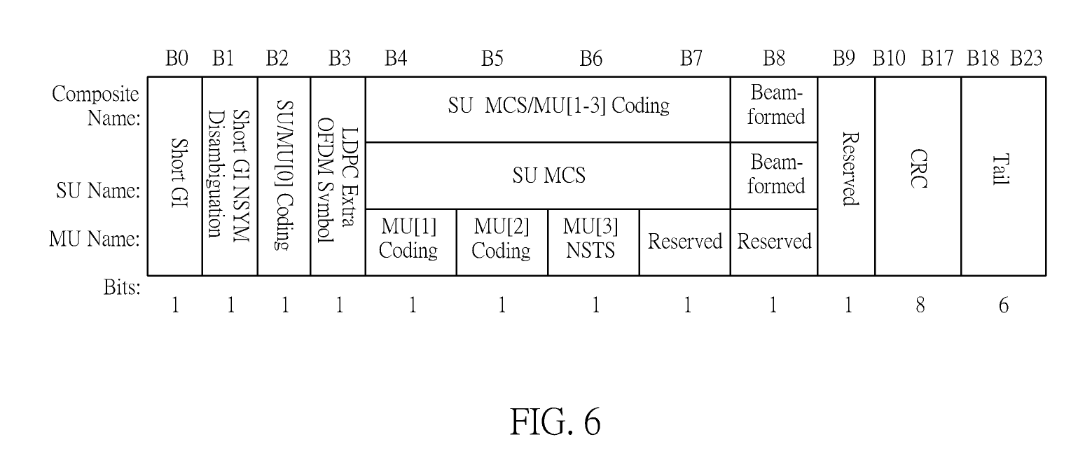

FIG. 6 illustrates some fields of a SIG structure used for determining Wi-Fi PHY capabilities in the method shown in FIG. 2 according to another embodiment of the present invention. For example, this SIG structure can be a VHT-SIG-A1 structure. For implementation details of the VHT-SIG-A1 structure, please refer to the associated standards or proposals.

According to this embodiment, after receipt of the PHY SIG, the control module 120 may determine whether the following payload cannot be decoded due to insufficient capabilities of the electronic device, based on some fields of this SIG structure. Examples of these fields may include, but not limited to, those of VHT SIG (for IEEE 802.11ac) such as Bandwidth (BW), STBC, Single/Multiple User (SU/MU), NSTS, Short GI, LDPC, MCS Set, and Maximum MPDU Length.

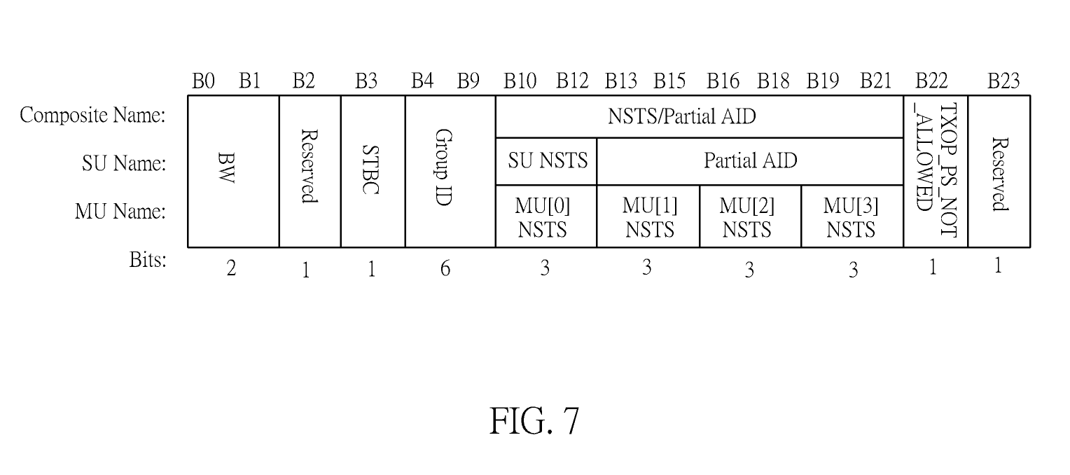

FIG. 7 illustrates some fields of a SIG structure used for determining Wi-Fi PHY capabilities in the method shown in FIG. 2 according to another embodiment of the present invention. For example, this SIG structure can be a VHT-SIG-A2 structure. For implementation details of the VHT-SIG-A2 structure, please refer to the associated standards or proposals.

According to this embodiment, after receipt of the PHY SIG, the control module 120 may determine whether the following payload cannot be decoded due to insufficient capabilities of the electronic device, based on some fields of this SIG structure. Examples of these fields may include, but not limited to, those of VHT SIG (for IEEE 802.11ac) such as BW, STBC, SU/MU, NSTS, Short GI, LDPC, MCS Set, and Maximum MPDU Length.

According to some embodiments, examples of these fields may include, but not limited to, Color bit (for IEEE 802.11ah).

Based upon the method 200 and the associated apparatus 100, the electronic device can detect (or recognize) the conditions that the received packets do not match its AID or BSSID according to the SIG structure (e.g. the VHT-SIG structure). As a result, the electronic device (more particularly, the transceiver 110) may enter the doze state for the remaining packet time derived based on the transmission time parameter mentioned in Step 220 (e.g. the L-SIG TX time or the related SIG TX time). For example, in a situation where the electronic device plays the role of an access point (AP) station (STA), this AP STA may enter the doze state when the received packets meet at least one (e.g. one or more) of the following conditions:

(1A). Group ID is not equal 0 (Not addressed to AP); and
(1B). PARTIAL_AID is neither equal to 0 nor does it match the AP's BSSID.

In another example, in a situation where the electronic device plays the role of a non-AP STA, this non-AP STA may enter the doze state when the received packets meet at least one (e.g. one or more) of the following conditions:

(2A). Not a member of the group on receipt of a MU-PPDU;
(2B). PARTIAL_AID is neither equal to 0 nor does it match the STA's partial AID on receipt of a SU-PPDU; and
(2C). NUM_STS equal to 0 if it is a member of group on receipt of a MU-PPDU.

According to some embodiments, new PHY header designs may be applied to the method 200 and the associated apparatus 100, and more particularly, the opportunistic packet-based power saving control scheme. For example, TXOP remaining time may be added to the next generation of PHY SIG. The STA can keep the latest NAV value even if the STA enter the doze state when recognizing that the received packets do not match its AID or BSSID via PHY SIG. Thus, the STA do not need to receive the whole of a packet, including PHY header and payload, to update the NAV. In addition, the STA can access medium immediately after wake up, and does not need to wait for the time of dot11VHTPSProbeDelay.

According to some embodiments, the electronic device can detect (or recognize) the conditions that the received packets do not match its AID or BSSID according to the SIG structure (e.g. the VHT-SIG structure). As a result, the electronic device (more particularly, the transceiver 110) may enter the doze state for the remaining packet time derived based on the transmission time parameter mentioned in Step 220 (e.g. the L-SIG TX time or the related SIG TX time). At the meanwhile, the electronic device can update the NVA based on the remaining packet time derived based on the transmission time parameter mentioned in Step 220 (e.g. the TX time in PHY SIG). In addition, the STA role played by the electronic device can access medium immediately after wake up. Some implementation details regarding the new PHY header designs are illustrated in Table 1.

TABLE 1

| Condition | GROUP_ID | PARTIAL_AID |
|---|---|---|
| Addressed to AP | 0 | BSSID[39:47] |
| Addressed to Mesh STA | 0 | RA[39:47] |
| Sent by an AP and | 63 | (dec(AID[0:8]) + dec(BSSID[44:47] ⊕ BSSID[40:43]) (9-8a) × |
| addressed to a STA associated | | 2⁵) mod 2⁹ |
| with that AP or | | (#S418)where |
| sent by a DLS or TDLS | | ⊕ is a bitwise exclusive OR operation |
| STA in a direct path to a | | mod X indicates the X-modulo operation |
| DLS or TDLS peer | | dec(A[b:c]) is the cast to decimal operator where b is scaled by |
| STA(#4397) | | 2⁰ and c by 2^{c·b} |
| Otherwise | 63 | 0 |

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing opportunistic power saving in an electronic device, the method comprising the steps of:
wirelessly receiving at least one portion of a header of a packet, wherein the packet is wirelessly sent from outside the electronic device;
determining a transmission time parameter of the packet according to the at least one portion of the header, for timing control of packet-based dozing; and
according to header information within the packet, selectively controlling a transceiver of the electronic device to enter a doze state during a remaining transmission time of the packet, to reduce power consumption of the electronic device.

2. The method of claim 1, wherein the step of selectively controlling the transceiver of the electronic device to enter the doze state during the remaining transmission time of the packet to reduce the power consumption of the electronic device further comprises:
utilizing a timer module within the electronic device to perform at least one timing operation according to the transmission time parameter;
according to the header information within the packet, controlling the transceiver to stay in the doze state during the remaining transmission time of the packet; and
based upon the at least one timing operation, controlling the transceiver to exit the doze state when the remaining transmission time expires.

3. The method of claim 2, wherein the step of selectively controlling the transceiver of the electronic device to enter the doze state during the remaining transmission time of the packet to reduce the power consumption of the electronic device further comprises:
based upon the at least one timing operation, controlling the transceiver to exit the doze state when the remaining transmission time expires, to wirelessly receive at least one portion of a next packet.

4. The method of claim 1, wherein the step of selectively controlling the transceiver of the electronic device to enter the doze state during the remaining transmission time of the packet to reduce the power consumption of the electronic device further comprises:
according to the header information within the packet, determining whether the packet is non-related to the electronic device, to selectively control the transceiver to enter the doze state during the remaining transmission time of the packet.

5. The method of claim 4, wherein the header information comprises an Association Identifier (AID); and the step of selectively controlling the transceiver of the electronic device to enter the doze state during the remaining transmission time of the packet to reduce the power consumption of the electronic device further comprises:
when the AID in the packet does not match that of the electronic device, controlling the transceiver to enter the doze state during the remaining transmission time of the packet.

6. The method of claim 4, wherein the header information comprises a Basic Service Set Identification (BSSID); and the step of selectively controlling the transceiver of the electronic device to enter the doze state during the remaining transmission time of the packet to reduce the power consumption of the electronic device further comprises:
when the BSSID in the packet does not match that of the electronic device, controlling the transceiver to enter the doze state during the remaining transmission time of the packet.

7. The method of claim 1, wherein the step of selectively controlling the transceiver of the electronic device to enter the doze state during the remaining transmission time of the packet to reduce the power consumption of the electronic device further comprises:
according to the header information within the packet, determining whether the packet is non-decodable based on predetermined capabilities by the electronic device, to selectively control the transceiver to enter the doze state during the remaining transmission time of the packet.

8. The method of claim 7, wherein the header information comprises a data rate; and the step of selectively controlling the transceiver of the electronic device to enter the doze state during the remaining transmission time of the packet to reduce the power consumption of the electronic device further comprises:
when the data rate is an unsupported data rate of the electronic device, controlling the transceiver to enter the doze state during the remaining transmission time of the packet.

9. The method of claim 1, wherein the header information comprises a data rate; and the step of selectively controlling the transceiver of the electronic device to enter the doze state during the remaining transmission time of the packet to reduce the power consumption of the electronic device further comprises:
when the data rate does not match a predetermined data rate of the electronic device, controlling the transceiver to enter the doze state during the remaining transmission time of the packet.

10. The method of claim 1, wherein the at least one portion of the header is wirelessly received by the electronic device through the transceiver before a connection between the electronic device and a source of the packet is established.

11. An apparatus for performing opportunistic power saving in an electronic device, the apparatus comprising at least one portion of the electronic device, the apparatus comprising:
a transceiver arranged for wirelessly receiving at least one portion of a header of a packet, wherein the packet is wirelessly sent from outside the electronic device; and
a control module, coupled to the transceiver, arranged for determining a transmission time parameter of the packet according to the at least one portion of the header, for timing control of packet-based dozing, wherein according to header information within the packet, the control module selectively controls the transceiver of the electronic device to enter a doze state during a remaining transmission time of the packet, to reduce power consumption of the electronic device.

12. The apparatus of claim 11, further comprising:
a timer module within the electronic device, arranged for performing at least one timing operation according to the transmission time parameter;
wherein according to the header information within the packet, the control module controls the transceiver to stay in the doze state during the remaining transmission time of the packet; and
based upon the at least one timing operation, the control module controls the transceiver to exit the doze state when the remaining transmission time expires.

13. The apparatus of claim 12, wherein based upon the at least one timing operation, the control module controls the transceiver to exit the doze state when the remaining transmission time expires, to wirelessly receive at least one portion of a next packet.

14. The apparatus of claim 11, wherein according to the header information within the packet, the control module determines whether the packet is non-related to the electronic device, to selectively control the transceiver to enter the doze state during the remaining transmission time of the packet.

15. The apparatus of claim 14, wherein the header information comprises an Association Identifier (AID); and when the AID in the packet does not match that of the electronic device, the control module controls the transceiver to enter the doze state during the remaining transmission time of the packet.

16. The apparatus of claim 14, wherein the header information comprises a Basic Service Set Identification (BSSID); and when the BSSID in the packet does not match that of the electronic device, the control module controls the transceiver to enter the doze state during the remaining transmission time of the packet.

17. The apparatus of claim 11, wherein according to the header information within the packet, the control module determines whether the packet is non-decodable based on predetermined capabilities by the electronic device, to selectively control the transceiver to enter the doze state during the remaining transmission time of the packet.

18. The apparatus of claim 17, wherein the header information comprises a data rate; and when the data rate is an unsupported data rate of the electronic device, the control module controls the transceiver to enter the doze state during the remaining transmission time of the packet.

19. The apparatus of claim 11, wherein the header information comprises a data rate; and when the data rate does not match a predetermined data rate of the electronic device, the control module controls the transceiver to enter the doze state during the remaining transmission time of the packet.

20. The apparatus of claim 11, wherein the at least one portion of the header is wirelessly received by the electronic device through the transceiver before a connection between the electronic device and a source of the packet is established.
